(19) United States
(12) Patent Application Publication
(10) Pub. No.: US 2005/0106950 A1
(43) Pub. Date: May 19, 2005

(54) HIGH VOLTAGE ELECTRICAL CONNECTION

(75) Inventors: Randy L. Fink, Warren, OH (US); William L. Stein SR., Warren, OH (US); James W. Albrecht, Solon, OH (US)

Correspondence Address: David P. Wood;DELPHI TECHNOLOGIES, INC., Legal Staff, Mail Code: 480-410-202, P.O. Box 5052, Troy, MI, 48007-5052, US

(73) Assignee: DELPHI TECHNOLOGIES, INC.

(21) Appl. No.: 10/991,575

(22) Filed: Nov. 18, 2004

Related U.S. Application Data
(63) Continuation of application No. 10/404,805, filed on Apr. 1, 2003, now Pat. No. 6,821,160.

(51) Int. Cl. H01R 13/514

(52) U.S. Cl. 439/752

(57) ABSTRACT

A high voltage electrical connection includes an electrical receptacle connector and a mating electrical plug connector. The electrical receptacle connector includes a receptacle that is mounted over a hole in the casing and fastened thereto with a plurality of terminated electrical leads that are attached to an internal component of an electrical device inside the casing and threaded through a hole in the casing. The receptacle has a chamber including an inlet at one end that is aligned with the hole in casing and an outlet at the other end. The electrical receptacle connector also includes a terminal holder and a terminal housing, both of which are made of electrical insulation material. The holder retains the plurality of terminals, of the respective leads is inserted into the chamber through the outlet of the receptacle and retained in the chamber. The terminal housing is then inserted into the chamber via the outlet with its flange being disposed in the outlet. The flange has a plurality of spaced holes, each one of which receives one of the plurality of terminals. Flange includes a stop to locate the terminal housing with respect to the receptacle in a longitudinal direction of the terminals, and an integral shroud that extends outwardly of the outlet whereby the electrical receptacle connector is adapted to receive the mating plug connector. The mating electrical plug connector which includes a plurality of terminals each attached to one of a plurality of electrical leads, a connector body housing the plurality of terminals, a terminal position assurance (TPA)/wire dress feature for the plurality of terminals and electrical leads, and an electromagnetic interference (EMI) shield.

### FIELD OF THE INVENTION

This invention relates to electrical connectors and more particularly to high power electrical connection for an electrical induction device.

### BACKGROUND OF THE INVENTION

An electrical induction device, such as an electric transmission requires a high voltage electrical connection on the order of 220 volts. The electric transmission which is a three phase induction machine controlled through electronic switching is fabricated with three electrical leads that are connected to an internal stator and lead out of a hole in the casing for connection to an external power source. Presently, pass through adapters and grommets are used to seal the hole in the casing.

### SUMMARY OF THE INVENTION

The present invention provides an electrical connection system for electrical leads that pass through a hole in a casing that seals the hole without any need for a pass through adapter or a grommet.

In one aspect, the invention provides a high voltage electrical receptacle connector that can be assembled outside of a casing using a plurality of short electric leads sticking out of a hole in the casing. The electrical receptacle connector is then attached to the casing to seal the hole in the casing. The electrical leads are preferably as short as possible to minimize lead feed back into the casing while being of sufficient length to be made part of the electrical receptacle connector that is assembled outside the casing so that the electrical leads can be connected to an external power source.

In another aspect, the invention provides a mating high voltage electrical plug connector for the receptacle connector that is assembled outside of the casing.

In still another aspect, the invention provides a high voltage terminal for the high voltage electrical plug connector.

### BRIEF DESCRIPTION OF THE DRAWINGS

FIG. 1 is a perspective view of a high power electrical connection in accordance with the invention;

FIG. 2 is a perspective view of the electrical receptacle connector that is part of the electrical connection shown in FIG. 1;

FIG. 3 is a cross section of the electrical receptacle connector taken substantially along the line 3-3 of FIG. 2 looking in the direction of the arrows;

FIG. 4 is a perspective view of a subassembly of the electrical receptacle connector that is shown in FIG. 2;

FIG. 5 is a cross section of the electrical receptacle connector taken substantially along the line 5-5 of FIG. 2 looking in the direction of the arrows with the terminal housing removed for clarity;

FIG. 6 is an exploded perspective view of the electrical receptacle connector shown in FIG. 2;

FIG. 7 is an exploded perspective view of the electrical plug connector that is shown in FIG. 1;

FIG. 8 is a cross section of the electrical plug connector taken substantially along the line 8-8 of FIG. 7 looking in the direction of the arrows;

FIG. 9 is a perspective view of one of the terminals of the electrical plug connector that is shown in FIG. 7;

FIG. 10 is an exploded perspective sectioned view of the electrical plug connector shown in FIGS. 7 and 8;

FIG. 11 is a perspective rear view of the electrical plug connector that is shown in FIG. 7,

FIG. 12 is a perspective front view of the electrical plug connector that is shown in FIG. 7, and

FIG. 13 is a perspective section of the high power electrical connection of FIG. 1 showing details of an interruption link and mating connectors.

### DETAILED DESCRIPTION OF PREFERRED EMBODIMENTS

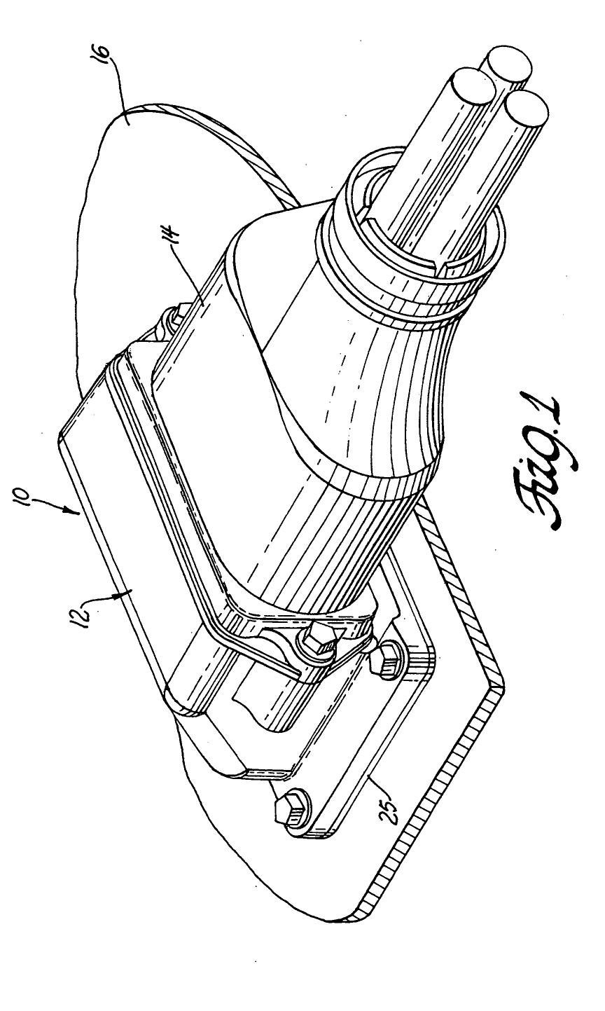

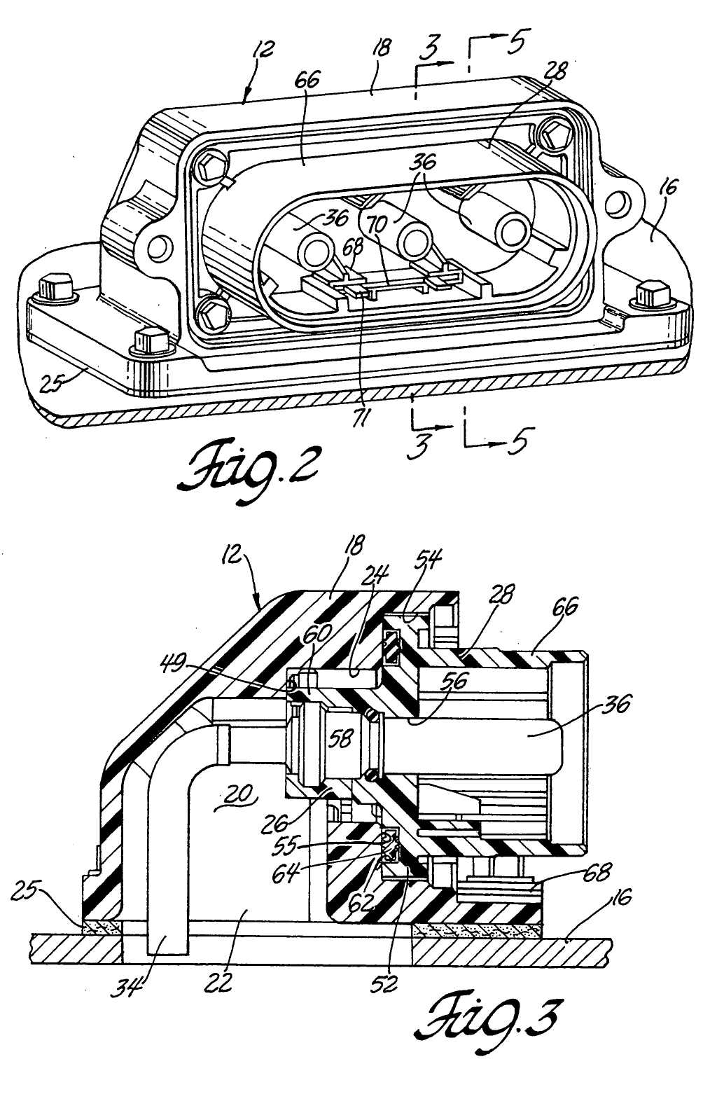

Referring now to the drawings, FIG. 1 shows a high voltage electrical connection 10 of the invention comprising an electrical receptacle connector 12 and a mating electrical plug connector 14. The electrical receptacle connector 12 which is attached to a motor casing 16 is shown in detail in FIGS. 2 through 6.

Referring now to FIGS. 2 and 3, the electrical receptacle connector 12 comprises a right angled metal receptacle 18 that is mounted over the hole in the casing 16 and fastened to the motor casing 16 with bolts or the like. Receptacle connector 12 has an internal chamber 20 including an inlet 22 at one end that is aligned with the hole in casing 16 and a stepped outlet 24 that is perpendicular to the inlet. A compression gasket (25) is disposed between the receptacle 18 and the motor casing 16 to seal the interface between receptacle 18 and motor casing 16.

Receptacle connector 12 further comprises a terminal holder 26 and a terminal housing 28, both of which are made of thermoplastic or other suitable electrical insulation material. Holder 26 is used in assembling receptacle connector 12 outside of casing 16 as explained below.

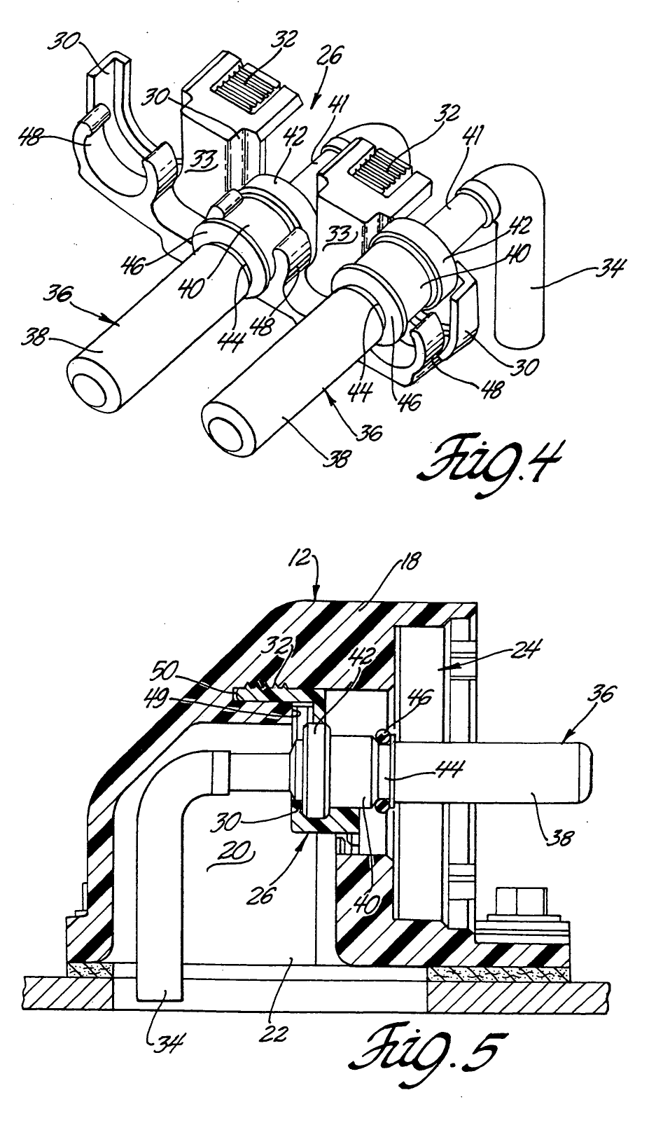

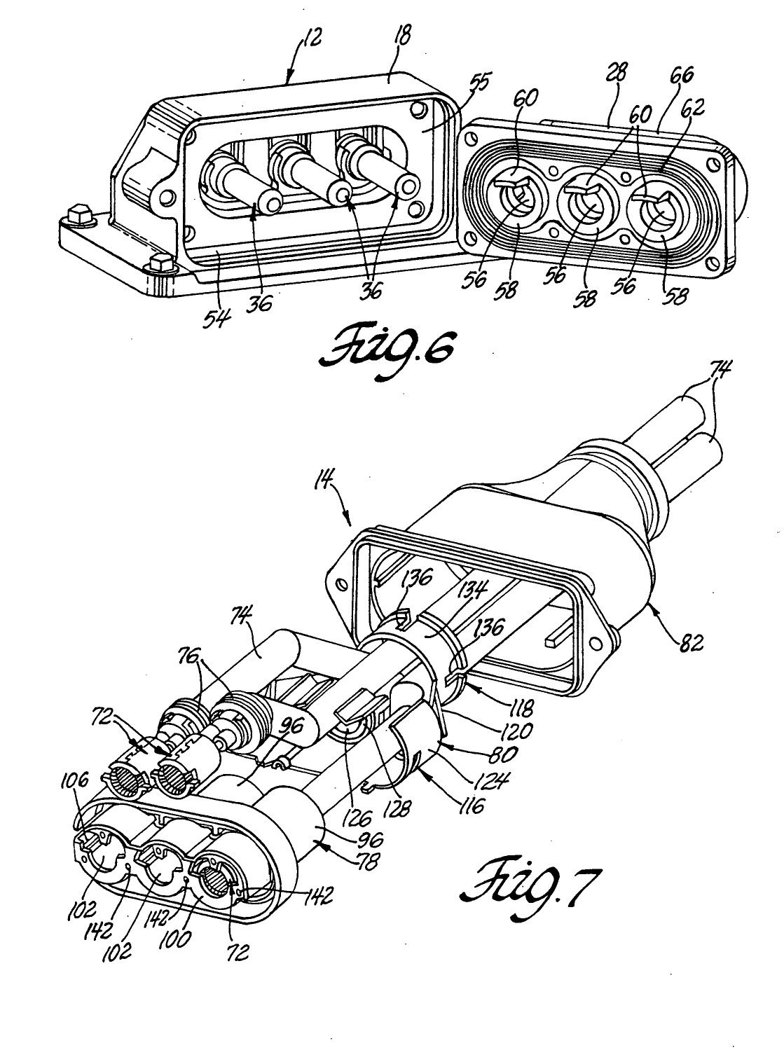

Referring now to FIGS. 4 and 5, terminal holder 26 comprises a plurality of laterally spaced terminal retainers 30 and a plurality of press tabs 32. Each press tab 32 is located at the top of a pedestal 33 that is disposed between a pair of terminal retainers 30 as best shown in FIG. 4. Electrical leads 34 are attached to an internal component of the electrical device inside casing 16 (such as the stator of an electric transmission) and threaded through the hole. Electrical leads 34 are preferably terminated before attachment to the internal component.

In either event, the electrical leads 34 are terminated with barrel type terminals 36 that have a barrel shaped contact 38 at one end and an opposite end 40 that is attached to the lead core 41 at an insulation stripped end of the electric lead 34, usually by a crimping operation. The opposite or attachment end 40 also includes an end collar 42 and an annular recess 44. Annular recess 44 which is spaced inwardly of the end collar 42 toward the contact 38 receives an elastomeric O-ring seal 46.

Each terminal 36 is held in one of the terminal retainers 30 by a clip 48 of holder 26 with the end collar 42 of each terminal 36 cooperating with its associated clip 48 and retainer 30 for axial retention of the terminal 36 as best shown by the terminal 36 in the middle retainer 30 in FIG. 4.

FIG. 4 shows a open retainer 30 at the left, a retained terminal 36 in the middle retainer 30 and a terminal 36 being inserted into the retainer 30 at the right. When three terminals 36 are retained in holder 26, holder 26 is pushed through stepped outlet 24 of chamber 20 into receptacle 18 until holder 26 engages shoulder 49 and press tabs 32 engage in retention slots 50 to retain the holder 26 in receptacle 18 as best shown in FIG. 5. The use of holder 26 and above assembly procedure minimizes the extra length of leads 34 that must be fed back into casing 16 because the leads 34 extend beyond their assembled position shown in FIG. 5 only a short distance (about 10 mm) for assembly into holder 24. Terminals 36 are preferably male pin terminals.

Referring now to FIGS. 2, 3 and 6, the terminal housing 28 comprises a flange 52 that fits in the intermediate part 54 of the three part stepped outlet 24 of chamber 20 in receptacle 18 against a back wall 55. Flange 52 has a plurality of spaced holes 56 extending through the flange, each hole 56 receiving one of the terminals 36. An integral terminal collar 58 extends from the inner side of flange 52 for each hole 56 as best shown in FIGS. 3 and 6. The terminal collar 58 cooperates with the O-ring seal 46 of the associated terminal 36 to seal the passage through the hole 56 as best shown in FIG. 3. Each terminal collar 58 includes a stop tab 60 that extends through a space in holder 26 and engages the shoulder 49 of receptacle 18 to locate the terminal housing 28 with respect to the receptacle 18 in the longitudinal direction of the terminals 36. The inner side of flange 52 includes an oval shaped groove 62 that receives an oval shaped face seal 64 that engages the back wall 55 of the receptacle 18 to seal the interface between the terminal housing 28 and the receptacle 18 as best shown in FIGS. 3 and 6. The face seal 64 is compressed when flange 52 is bolted to receptacle 18 by bolts that extend through flange 52 outwardly of face seal 64 as shown in FIG. 3.

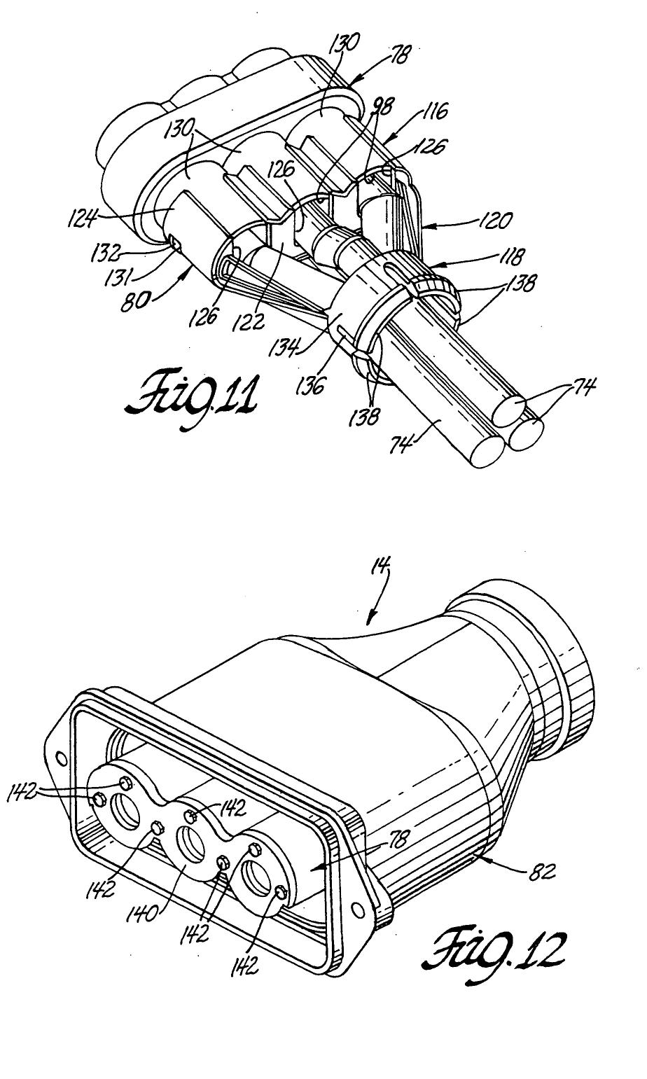

The outer side of flange 52 has an integral shroud 66 as shown in FIGS. 2 and 3. The inside of shroud 66 is shaped to receive electrical plug connector 14 as explained below. Shroud 66 includes a pair of laterally spaced slots 68 that hold for a flat metal electrical interruption link 70 that is best shown in FIG. 13. The flat metal link 70 has two extended electrical arms 71. Mating plug connector 14 houses two female terminals 14, which are locked in laterally spaced terminal housings 143 of connector body 78 via flexible arms 146 as best shown in FIGS. 10 and 13. The female terminals 141 have an environmental seal 144 crimped to the terminal and the electrical lead. A terminal position feature 145 prevents female terminals 141 from backing out of connector body 78.

Female terminals 141 engage the respective electrical arms 71 of flat metal link 70 when the electrical receptacle connector 12 and the electrical plug connector 14 are mated to form the high voltage electrical connection 10. This drains off residual voltage stored within the high voltage connection 10 during use and thus eliminates the possibility of an electrical discharge when the electrical plug connector 14 is unplugged.

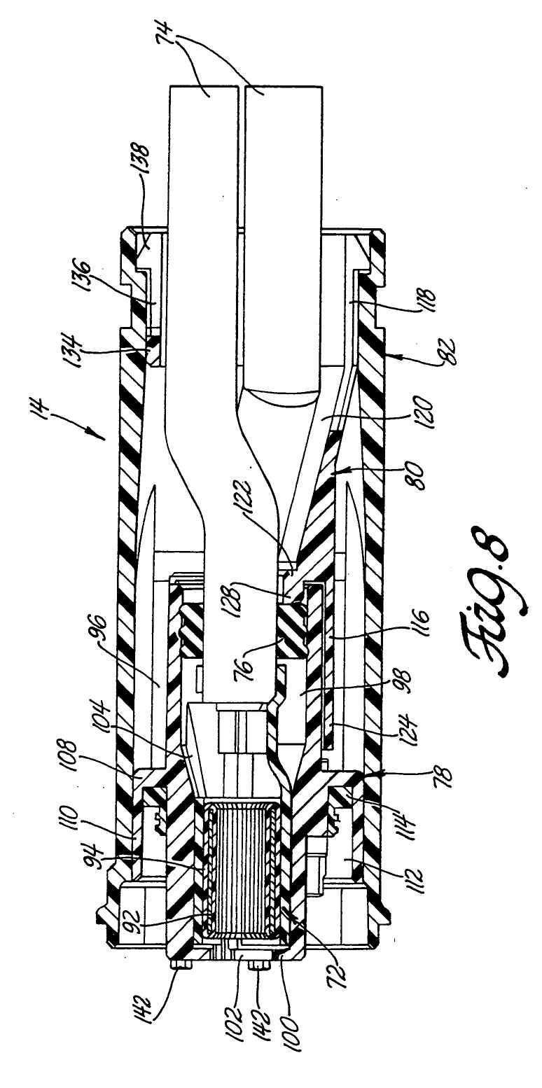

Details of the electrical plug connector 14 of FIG. 1 are shown in FIGS. 7 through 12.

Referring now to FIGS. 7 and 8, the electrical plug connector 14 comprises a plurality of terminals 72 each attached to an electrical lead 74 and holding a cable seal 76. The electrical connector 14 includes a connector body 78 housing terminals 72, a terminal position assurance (TPA)/wire dress feature 80 for terminals 72 and electrical leads 74 and an electromagnetic interference (EMI) shield 82.

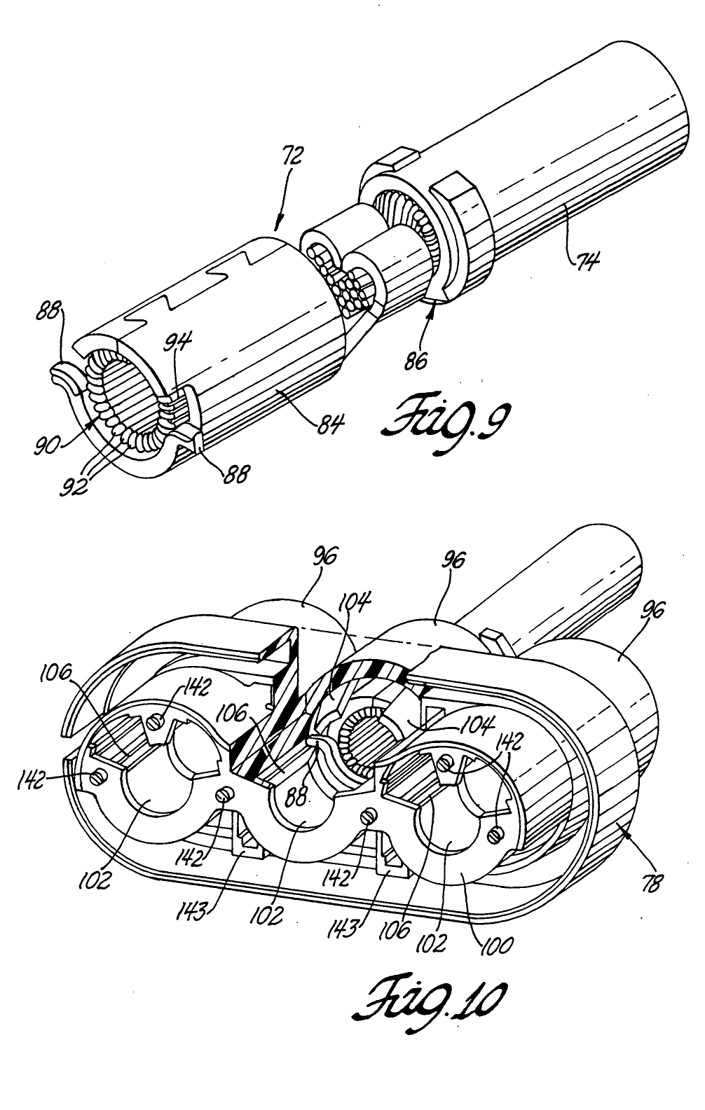

A typical terminal 72 is shown in FIG. 9. It comprises a contact barrel 84 at one end and an attachment portion 86 at the opposite end. Attachment portion 86 comprises convention core and insulation crimp wings that are crimped onto the insulation stripped core end and adjacent insulation jacket of electrical lead 74 in a conventional manner. Contact barrel 84 is a split barrel with the seam of the barrel being formed by dove-tailed or interlocking tabs and slots to guard against the split barrel opening up after prolonged use. The front of contact barrel 84 has two diametrically opposed wings 88 that extend outwardly of the contact barrel. Terminals 72 are preferably female terminals and preferably also include a female contact insert 90 that comprises a plurality of resilient contact wires 92 inside a support sleeve 94 with the ends of the resilient contact wires 92 wrapped around the ends of the support sleeve 94 as best shown in FIGS. 8 and 9 and slightly bowed inwardly away from the support sleeve 94 between the ends of the support sleeve 94.

Referring now to FIGS. 7, 8 and 10, connector body 78 comprises a plurality of cylindrical portions 96 arrayed side by side with their abutting side walls integrally joined together. Each cylindrical portion 96 forms a cylindrical terminal cavity 98 which receives a terminal 72 attached to one of the electrical leads 74 as best shown in FIG. 8. Each terminal cavity 98 has a partial front wall 100 defining a tri-lobal opening 102 at the contact end as best shown in FIGS. 7 and 10. Tri-lobal opening 102 has a central or concentric lobe to provide access to the female terminal 72 and two eccentric lobes which facilitate the molding of two resilient, cantilevered, retention fingers 104 inside the cylindrical terminal cavity 98 that are integrally attached to the side wall of the enlarged rearward portion of each terminal cavity as best shown in FIGS. 8 and 10. The reduced forward portion of each terminal cavity 98 has diametrically opposed guide slots 106 for receiving the terminal wings 88.

Terminals 72 are loaded into the terminal cavities 98 from the conductor or lead end. During the loading process, retention fingers 104 are pushed outwardly by contact barrels 84 as contact barrels enter the reduced forward portions oriented and guided by terminal wings 88 entering guide slots 106 as best shown in FIG. 10. Retention fingers 104 are held outwardly until the terminals 72 are fully inserted into the terminal cavities 98 whereupon the retention fingers snap down behind the contact barrels 84 to retain the contact barrels between the retention fingers 104 and the partial front walls 100 as best shown in FIG. 8.

Connector body 78 also includes a medial flange 108 that supports an annular hood 110 that extends toward the forward contact end of the connector body 78 to form an annular groove 112. Groove 112 receives the shroud 66 of the receptacle connector 12 when the plug connector 14 is mated to the receptacle connector 12. An annular elastomeric seal 114 is disposed at the inner closed end of the annular groove 112 to seal the interface between the plug connector 14 and the receptacle connector 12.

After the terminals 72 are loaded into the terminal cavities 98, cable seals 76 are slid onto each electrical lead 74 into a position behind the associated terminal 72. The TPA/wire dress 80 which is pre-positioned around the electrical wires 74 as shown in FIG. 7 is then assembled to the connector body 78 as shown in FIG. 8.

Referring now to FIGS. 7, 8 and 11, the TPA/wire dress 80 comprises a forward TPA portion 116 and a rearward wire dress portion 118 connected together by a transition 120. The TPA portion 116 includes an end wall 122 and a forward projecting hood 124 that is sized and shaped to fit over the rearward end of connector body 78. End wall 122 has a plurality of lead slots 126 with integral forward projecting collars 128 that align with the terminal cavities 98 respectively. Hood 124 has a plurality of loading slots 130 that align with lead slots 126 respectively and two retention slots 132 as best shown in FIG. 11.

The top of transition 120 is open while the rearward dress portion 118 is a closed collar 134 as shown in FIGS. 7 and 11. Collar 134 has a plurality of longitudinal slots 136 that are open at the rear or conductor end which includes a flange 138 that is divided into a number of segments by the slots 136. Slots 136 increase the flexibility of the conductor end portion of collar 134 so that the flange segments can be depressed radially inwardly

The TPA/wire dress 80 which as stated above, is pre-positioned around the electrical leads 74 so that the electrical leads 74 extend through collar 134 as shown in FIG. 7. The electrical leads 74 are then loaded into the lead slots 126, respectively, via loading slots 130. The TPA/wire dress 80 is then slid forward so that the projecting hood 124 slides onto the rearward portion of the connector body 78 until the hood 124 is locked in place by lock tabs 131 engaging in retention slots 132 as best shown in FIG. 11. When hood 124 is locked in place, the forward projecting collars 128 of end wall 122 project into the ends of the terminal cavities 98 and engage the cable seals 76 as best shown in FIG. 8, thus assuring that the cable seals 76 as well as the terminals 72 are properly located in the terminal cavities 98.

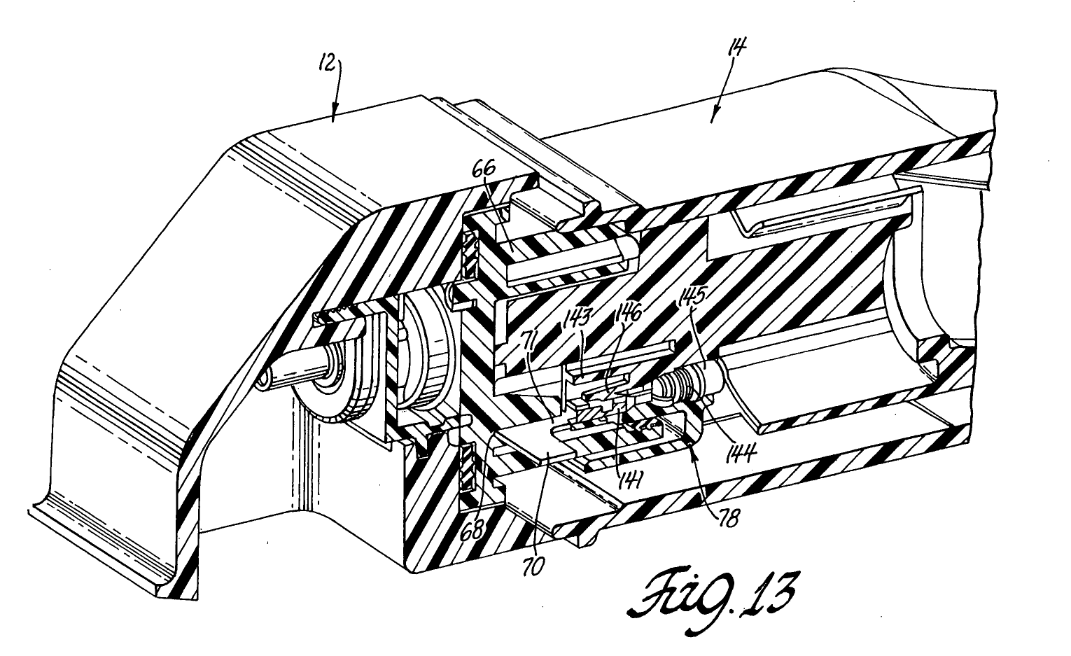

After the TPA/wire dress 80 is secured in place, the EMI shield 82 which is also pre-positioned around the electrical wires 74 as shown in FIG. 7, is then slid forward over the collar 134 into place over the annular hood 110 of the connector body 78 as shown in FIGS. 8 and 12. A tri-annular gasket 140 is then attached to the front wall 100 of the connector body 78 using the integral studs 142 of the front wall which are headed over to keep the face seal 140 in place as shown in FIG. 12.

The electrical plug connector 14 is then plugged into the electrical receptacle connector 12 and held in place by two bolts as shown in FIG. 1.

The foregoing description discloses and describes various aspects and embodiments of the present invention. One skilled in the art will readily recognize from such description, and from the accompanying drawings and claims, that various changes, modifications and variations can be made therein without departing from the spirit and scope of the present invention, and also such modifications, changes and variations are intended to be included within the scope of the following claims.

1. An electrical plug connector for a plurality of electrical leads comprising:
a plurality of terminals each attached to one of the plurality of electrical leads,
a connector body housing the plurality of terminals,
a terminal position assurance(TPA)/wire dress feature for the plurality of terminals and electrical leads,
and an electromagnetic interference (EMI) shield,
wherein the connector body comprises a plurality of cylindrical portions, each cylindrical portion forming a cylindrical terminal cavity which receives one of the plurality of terminals attached to one of the plurality of electrical leads,
wherein the TPA/wire dress feature comprises a rearward wire dress portion that includes a closed collar and a forward TPA portion that includes a forward projecting hood that fits over the rearward end of the connector body and an end wall that has a plurality of lead slots with integral forward projecting collars that align with the terminal cavities respectively.

2. (Cancelled) The electrical plug connector as defined in claim 1 wherein the forward TPA portion includes a forward projecting hood that fits over the rearward end of the connector body.

3. The electrical plug connector as defined in claim 1 wherein a cable seal is disposed on each lead in a position behind the terminal.

4. The electrical plug connector as defined in claim 3 wherein the hood is configured to engage the cable seals, so as to assure that the cable seals and the terminals are properly located in the terminal cavities.

5. The electrical plug connector as defined in claim 1 wherein the hood has a plurality of loading slots that align with lead slots and retention slots, respectively.

6. (canceled)

7. (canceled)

8. The electrical plug connector as defined in claim 1 wherein the rearward wire dress portion is connected together with the forward TPA portion by a transition.

9. The electrical plug connector as defined in claim 8 wherein the top of the transition is open.
